(19) United States
(12) Patent Application Publication
(10) Pub. No.: US 2008/0142510 A1
(43) Pub. Date: Jun. 19, 2008

(54) Heated transfer pipe

(75) Inventors: Kyle B. Clark, Underhill, VT (US); Valery Kagan, Colchester, VT (US)

Correspondence Address: RISSMAN JOBSE HENDRICKS & OLIVERIO, LLP, 100 Cambridge Street, Suite 2101, BOSTON, MA, 02114, US

(73) Assignee: iTherm Technologies LP, Merrimack, NH (US)

(21) Appl. No.: 11/639,070

(22) Filed: Dec. 14, 2006

(51) Int. Cl. H05B 6/10

(52) U.S. Cl. 219/643; 219/424; 219/674

(57) ABSTRACT

Apparatus and method for inductive heating of a transfer pipe having a bore for transporting a flowable material. A heating coil assembly is disposed along an exterior length of the pipe for generating a magnetic flux for inductively heating the pipe and/or a material flowing in the bore. The coil configuration comprises a continuous coil having spaced-apart coil groups along the pipe length, with adjacent coil turns in each group. In various applications, such as for transporting molten metals from a furnace to a casting assembly, this coil configuration can provide one or more benefits including: reduced energy consumption by reducing thermal losses in the pipe and thus reducing the required temperature at which the molten material is delivered to the pipe; tighter temperature control; improved consistency of the molten material; increased heating efficiency, and/or greater thermal uniformity of the pipe and/or the molten material in the pipe.

### FIELD OF THE INVENTION

This invention relates to an apparatus and method for inductive heating of a pipe having a bore for transporting a flowable material, wherein a heating coil assembly is disposed along a length of the pipe for generating a magnetic flux for inductively heating the pipe.

### BACKGROUND OF THE INVENTION

It is common practice to inductively heat an article (e.g., a solid cylinder or hollow tube) of a magnetizable material, such as steel, by inducing an eddy current in the article. This eddy current is induced by an applied magnetic flux generated by passage of an alternating current through a heater coil wound around the article. The heat inductively generated in the article may then be transmitted to another article, e.g., a metal or polymer material flowing through a bore or channel of an inductively heated steel tube.

Various systems have been proposed which utilize different combinations of materials, structural heating elements, signal frequencies, etc., for such heating techniques. There is an ongoing need for an apparatus and method for heating a material in a bore which provides one or more of higher power density, tighter temperature control, reduced power consumption, longer operating life, and/or lower manufacturing costs.

### SUMMARY OF THE INVENTION

According to one embodiment of the invention, a method is provided for inductively heating a transfer pipe. The method includes providing a thermally conductive pipe having a bore for transporting a material; providing a continuous coil along an exterior length of the pipe, the coil being inductively coupled to the pipe and having spaced-apart coil groups along the pipe length with adjacent coil turns in each group; and supplying a signal to the coil to generate a magnetic flux for inductively heating the pipe length, the signal comprising current pulses providing high frequency harmonics in the coil.

The heating step may provide various functions. For example, the heating step may include maintaining a temperature of the pipe length and/or a material in the bore along the pipe length within a defined temperature range. The temperature of the pipe/material may be maintained with either a flow of material in the bore, or with no flow of material in the bore. The heating step may include increasing a temperature of a material in the bore along the pipe length to within a defined temperature range. Alternatively, the heating step may include preheating the pipe length prior to transporting a material in the bore. In various applications, the heating step may include maintaining a temperature of a material in the bore at at least one end of the pipe length within a defined temperature range. The heating step may include maintaining a flow of material in the bore along the pipe length, wherein the material is in a temperature range of 400-700° C.

In one embodiment, the pipe may transport a molten material to a metal casting apparatus.

The heating step may include resistive heating of the coil, and at least a portion of the generated resistive heat may be thermally conducted to the pipe length.

The heating step may further include maintaining a temperature of the pipe length below a Curie temperature of the pipe.

In another embodiment, an inductively heated transfer pipe assembly is provided comprising: a thermally conductive pipe having a bore for transporting a material; a continuous coil provided along an exterior length of the pipe, the coil being inductively coupled to the pipe, and the coil having spaced apart coil groups along the pipe length, with adjacent coil turns in each group; and a source for supplying a signal to the coil for generating a magnetic flux for inductive heating of the pipe length, the signal comprising current pulses providing high frequency harmonics in the coil.

In various embodiments, the coil groups may be substantially evenly spaced along the pipe length. The coil groups may have the same number of turns per group, or a different number of turns per group. The coil groups may be unevenly spaced along the pipe length. Multiple layers of one or more coils may be provided along at least a portion of the pipe length for intensifying the magnetic flux. These multiple layers may be provided adjacent at least one end of the pipe length. The coil may have a relatively greater number of turns adjacent at least one end of the pipe length.

In select embodiments, the pipe is provided between one or more of a furnace, pump, mold and rollers. The pipe may be disposed between a source of molten metal material and a casting assembly.

The assembly and method may be particularly useful in applications involving a relatively long and skinny transfer pipe. For example, it may be particularly useful where the aspect ratio of the pipe length to the pipe outer diameter along the pipe length is at least 5:1, more preferably at least 10:1, and still more preferably at least 25:1. In various such embodiments, the coil and pipe length may form a load having a damping coefficient in a range of 0.1 to 0.9.

The coil turns may be wound in a substantially cylindrical form around the pipe. The turns may be helical or non-helical. The coil turns may form a serpentine pattern.

In various embodiments, the coil may be maintained at a lower temperature than the pipe length. Alternatively, the coil may be at a higher temperature than the pipe length. An outer sheath may be provided such that the coil is disposed between the outer sheath and the pipe. The outer sheath may provide thermal insulation. Thermal insulation may also be provided between the outer sheath and the coil. The outer sheath may be a flux concentrator for increasing the flux density in the pipe. In various embodiments, the coil and pipe may be disposed such that: the coil is wrapped around an exterior surface of the pipe; the coil is disposed in a dielectric body which surrounds an exterior surface of the pipe; and/or there is a gap between the coil and an exterior surface of the pipe in a range of 0.02 to 0.25 inches.

In a further alternative embodiment, a method is provided comprising: providing a thermally conductive pipe having a bore for transporting a material; providing a continuous coil along an exterior length of the pipe, the coil being inductively coupled to the pipe and having spaced-apart coil groups along the pipe length, with adjacent coil turns in each group; supplying a signal to the coil to generate a magnetic flux for inductive heating of the pipe length, the signal comprising current pulses providing high frequency harmonics in the coil; and selecting a coil configuration having at least a number (n) of a coil groups and at least a number (N) of turns per coil group to provide a desired heating efficiency for heating or maintaining the pipe length and/or a material in the bore along the pipe length at a desired temperature profile.

Again, this method may be particularly useful for an aspect ratio of the pipe length to the pipe outer diameter along the pipe length of at least 5:1, more preferably 10:1, and still more preferably at least 25:1.

The coil configuration may be selected to provide a total coil resistance Rₜₒₜ within a range of from Rₘᵢₙ to Rₘₐₓ, for a required power input Pₜₒₜ to heat or maintain a temperature profile of the pipe length and/or a material in the bore along the pipe length. The lower and upper limits Rₘᵢₙ and Rₘₐₓ may be determined based on current and voltage limits of the coil and/or a source of the signal.

In yet another embodiment, a method is provided comprising: providing a thermally conductive pipe having a bore for transporting a material; providing a continuous coil along an exterior length of the pipe, the coil being inductively coupled to the pipe and having spaced-apart coil groups along the pipe length, with adjacent coils in each group; supplying a signal to the coil to generate a magnetic flux for inductive heating of the pipe; and providing a coil configuration having at least a number (n) of coil groups and at least a number (N) of turns in each coil group, wherein the coil configuration is determined by: determining a required total power Pₜₒₜ to heat or maintain the pipe length or a material in the bore along the pipe length at a desired temperature profile; determining, for a maximum voltage limit of the coil and a source of the signal, an average voltage Vₐᵥₑ; determining a maximum total resistance where Rₘₐₓ=V²ₐᵥₑ/Pₜₒₜ; determining the number (n) of coil groups and the number (N) of turns in each coil group such that the coil configuration provides a total resistance Rₜₒₜ less than Rₘₐₓ.

The coil configuration may be selected to provide a desired combination of heating efficiency and uniformity of thermal profile in one or more of the pipe length and a material in the bore along the pipe length.

The coil configuration may further be determined to provide a total resistance Rₜₒₜ greater than a minimum resistance Rₘᵢₙ, where Rₘᵢₙ is determined based on a maximum current limit of the coil.

These and other embodiments of the invention will be understood from in the following detailed description.

### BRIEF DESCRIPTION OF THE DRAWINGS

The above and further advantages of the invention may be better understood by referring to the following description in conjunction with the accompanying drawings in which:

FIG. 1a is a schematic view of a heated transfer pipe assembly according to one embodiment of the invention, disposed between a source of molten metal and a casting assembly;

FIG. 1b is a partial cut-away and exploded view of one end of a coil and pipe configuration as utilized in the transfer pipe assembly of FIG. 1a;

FIG. 2a is a schematic plan view of a heater coil assembly on a transfer pipe, useful in the embodiment of FIG. 1a, showing groups of coils evenly disposed along the length of the pipe;

FIG. 2b is a schematic plan view of another heater coil assembly on a transfer pipe similar to FIG. 2a, but showing multiple coil layers at each end of the transfer pipe;

FIG. 3a is a graph of temperature versus position along the pipe length, showing the thermal profile for a coil configuration of the type shown in FIG. 2a;

FIG. 3b is a graph of temperature versus position along the pipe length showing the thermal profile for the alternative coil configuration of FIG. 2b;

FIG. 4a is a partial cut-way view showing one end of a transfer pipe with multiple layers of coil groups;

FIG. 4b is a partial cut-away view showing an alternative end coil configuration with a transverse spiral coil section included in the end coil group;

FIG. 5a is an exterior perspective view of a curved transfer pipe section, as shown for example in the embodiment of FIG. 1a, for connecting a linear transfer pipe section to a casting assembly or furnace;

FIG. 5b is a partial sectional view of the assembly of FIG. 5a, taken along the section lines A-A;

FIG. 6a is a schematic view of two coil groups connected in series;

FIGS. 6b is a schematic view of two coil groups connected in parallel;

FIG. 7a is a partial sectional view of a traditional coil configuration showing the field generated in the pipe;

FIG. 7b is a partial sectional view of a new coil configuration showing for one discrete group of coils, the field generated in the pipe; and

FIG. 8 is a schematic view of a serpentine coil configuration.

### DETAILED DESCRIPTION

A heated transfer pipe for transporting a flowable material has numerous applications, including use in metal casting, injection molding, drilling rods, steam generators, oil pipes and asphalt machinery. The heated transfer pipe of the present invention may be used in any one or more of these applications. Other suitable applications will be readily apparent to those skilled in the art.

A particular application of a heated transfer pipe in accordance with one embodiment of the application will now be described. The application is in the field of metal casting, and in this example the pipe is provided for transporting molten metal from a furnace to a casting assembly.

In the metal casting industry it is common to transport molten metal from or between one or more of a furnace, a pump, casting rolls, and/or a casting mold. In order to reduce the overall energy consumption of the system, it is desirable to mitigate heat losses in the transfer system which transports the molten metal between these components. Currently, it is common practice to utilize thermally insulated transfer pipes, the pipes being insulated both on the inside and the outside, to reduce heat loss during the flow of material through the pipe. However, if the flowable material stops, the pipes may not remain sufficiently hot and the molten material will begin to solidify (freeze). Currently, when the flow of material stops there is a fixed amount of time (an operating window) before the material in the pipe begins to solidify. This time is a function of the temperature of the material, including the amount by which the temperature exceeds the liquidus temperature, and the properties of the transport system (e.g., thermal mass of the pipe, inner and outer diameters of the pipe, length of the pipe, ambient temperature, material composition of the pipe, etc.).

For example, a 6-foot length of thermally insulated steel pipe having an inner diameter of 1.5 inch and an outer diameter of 3 inches, for transporting molten metal at a temperature of 450° C., may have an operating window of about 3 minutes before the molten metal solidifies. When a freeze-up occurs, the transfer pipe must be unbolted at each end and a large torch used to melt the metal inside the pipe, enabling the pipe to be removed. The pipe is then placed in a furnace (a molten bath of the material) to remove the remaining molten material within the pipe, before the pipe is re-installed. This is an arduous process that is time-consuming, expensive, and dangerous as it involves handling of molten metals (such as lead), and use of a acetylene torch.

Still further, it is difficult to control the start-up (preheat) operation with current systems which use an unheated transfer pipe. If any part of the system (pump, furnace, rollers, mold) fails during start-up and the pipe is still cold, a freeze-up will occur. A typical casting line can tolerate perhaps one or two faulty start-ups, before freeze-up occurs.

While resistive heaters could be applied to preheat the pipe, there is a limitation on how fast the pipe can be preheated due to the limited rate of conductive heat transfer from a resistive heater to the pipe.

Alternatively, an inductive heater could be used to preheat the pipe. A typical inductive heating power supply, which provides a resonant frequency sinusoidal current signal to the heater coil, generally has poor inductive coupling between the coil and pipe and consequently produces a relatively low effective rate of heating of the pipe.

One or more of these limitations of the prior art transfer pipes can be overcome by use of the following embodiments of the invention. The benefits of the invention may include one or more of:
increasing the casting production up-time, e.g., by increasing the operating window until freeze-up;
lowering energy consumption by reduced temperature losses in the pipe and thus lowering the required temperature at which the molten material can be delivered to the pipe;
eliminating freeze-up;
reduced start-up (preheat) time;
maintaining tighter temperature control and consistency of the molten material;
adding heat to the molten material during conveyance through the transfer pipe, which may lower the required temperature at which the molten material can be input to the pipe;
higher power densities at the ends of the transfer pipe (where thermal losses are greatest);
more reliable high temperature operation.

### 1. Molten Metal Transfer Pipe Assembly

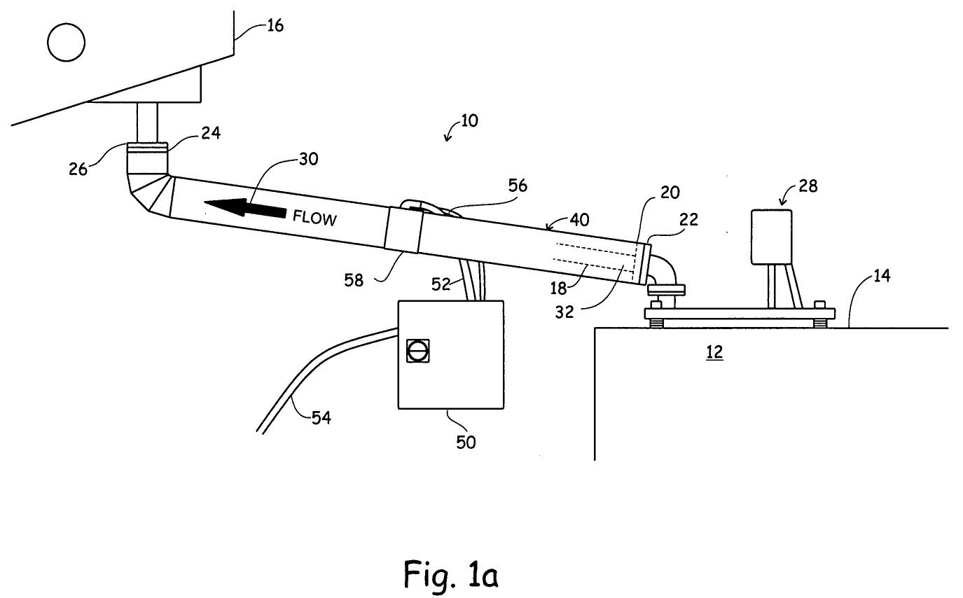

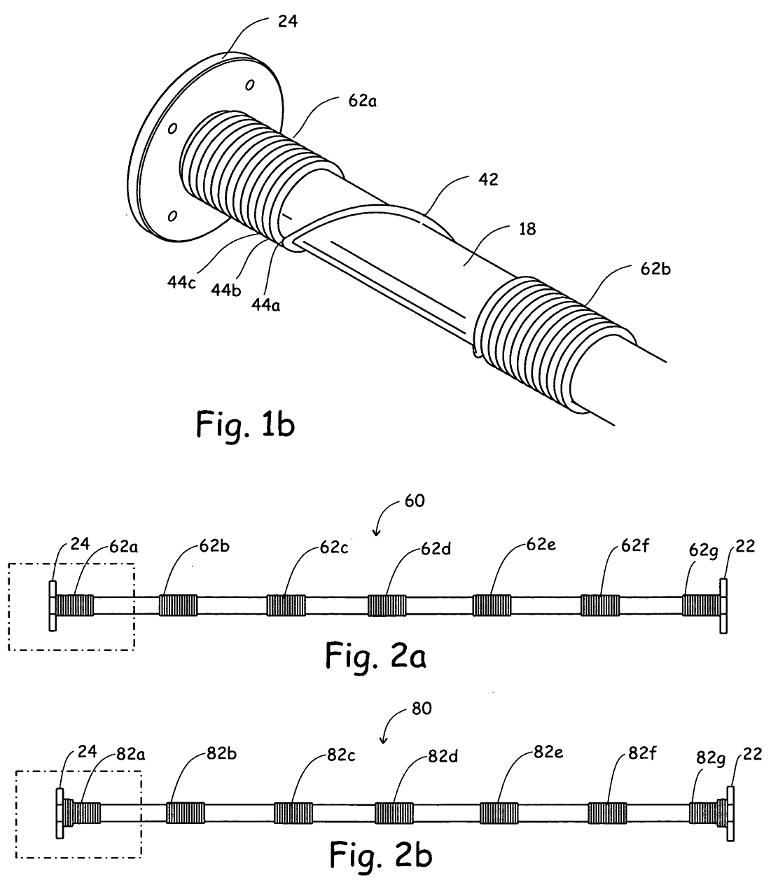

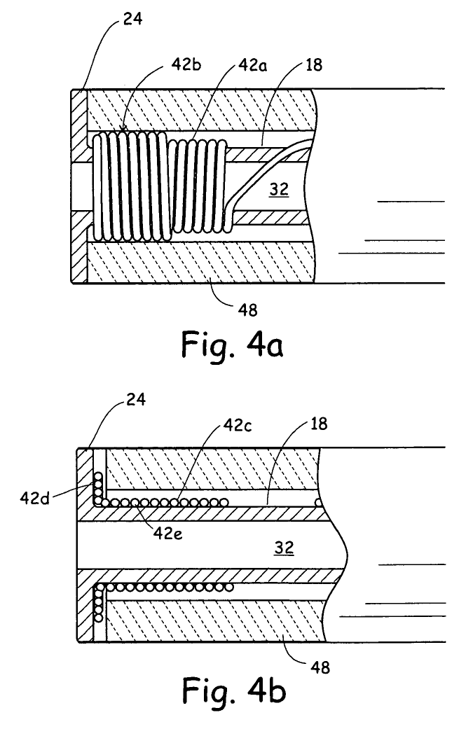

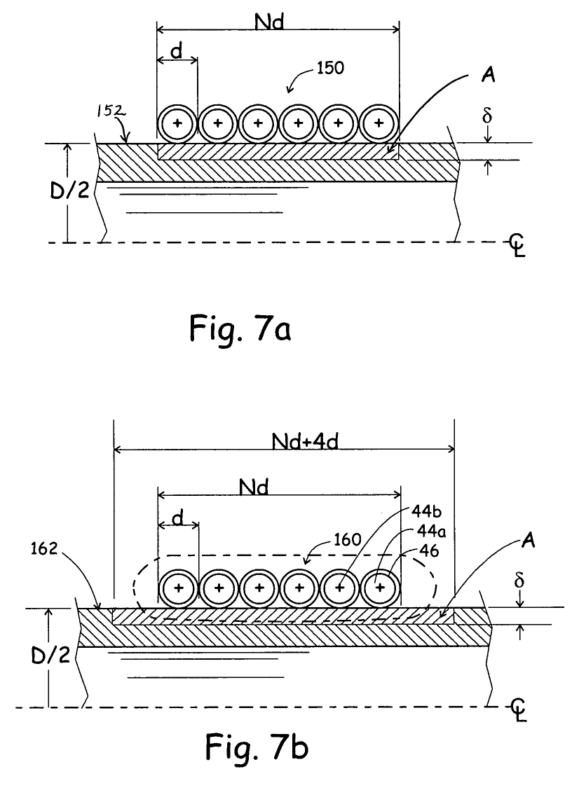

FIG. 1a is a schematic view of a lead transfer pipe assembly 10 for transporting molten lead 12 between a furnace 14, herein referred to as a lead pot, and a metal casting assembly 16, herein referred to as a tundish (a funnel or container for transferring molten metal into a mold). The assembly 10 includes a transfer pipe 18 (see FIG. 1b) extending between two end flanges, an input end flange 20 of pipe 18 being attached to a pump flange 22 adjacent the lead pot 14, and an opposite (output) end flange 24 of the pipe being attached to a tundish flange 26 adjacent the metal caster 16. A pump 28 mechanically forces molten lead 12 from the lead pot 14 into one end 20 of the pipe, causing a flow (see arrow 30) of the molten lead through a central axial bore 32 of the pipe 18 and out the exit end 24 to the metal caster. A heater coil assembly 40 is provided around the exterior of the pipe for heating the pipe. The coil assembly comprises a continuous coil 42 wrapped around the exterior of the pipe 18, the coil being configured as groups of coils, spaced apart, along the length of the pipe. In this example, as shown schematically in FIG. 2a, the coil groups (62a-62e) are substantially evenly spaced along the pipe length and operate as multiple inductors in series, as will be described hereinafter. Each coil turn 44a, 44b, 44c, . . . is covered by electrical insulation 46 (see e.g. FIG. 7b), and an outer sheath 48 of thermal insulation (see e.g., FIGS. 4a and 4b) covers the coil/pipe assembly.

A power supply 50 is connected by leads 52 to the heater coil assembly. The power supply 50, receiving input power from power cord 54, provides as output a current pulse signal with high frequency harmonics (described hereinafter) to the coil 42 via leads 52; this current pulse signal generates a magnetic flux in the ferromagnetic pipe 18 for inductive heating of the pipe. A thermocouple lead 56 provides feedback from a thermocouple (not shown) mounted on the pipe. An outer enclosure or sheath 46 provided over the coil reduces thermal losses and protects the operator from contact with the high temperature pipe 18.

This heated transfer system is designed to deliver liquid lead to the tundish 16 at the same temperature that it accepts the material at the lead pot 14, eliminating freeze-ups and saving energy by lowering the lead pot temperature. Thus, not only does it eliminate the production down-time of freeze-ups, it also reduces the required input melt temperature of the lead (received from lead pot 12) because of reduced thermal losses during transit to tundish (caster) 16.

In order to prevent freeze-up, the liquid transfer pipe 18 is preheated during start-up. The pipe 18 is also heated during normal operation to maintain the temperature of the pipe at or above a minimum operating temperature.

The transfer pipe will expand when heated (e.g., during preheating), and contract when cooled (e.g., during shut down). In order to accommodate this expansion and contraction and avoid damage to the pump, the pump is mounted so as to be movable (float) with respect to the pipe (e.g., by allowing the pump mounting bolts to slide in slots in the platform on which the pump and transfer pipe are mounted). An expansion joint 58 is also provided in the center of the pipe assembly to accommodate thermal induced dimensional changes between the pump and the sheath.

The pipe 18 in this example has an overall length of 78 inches, a pipe outer diameter of 2.275 inches, a pipe inner diameter of 1.5 inches, and is comprised of ANSI A335 steel available from Tioga Pipe Supply Company, Philadelphia, Pa., USA. The end flanges (22 and 26) are made from ANSI A387, and have an outer flange diameter of 6 inches, and a flange thickness of 0.5 inches.

The coil comprises a nickel-coated copper wire conductor wrapped with mica insulation and enclosed in a glass braid (commonly known as type MGT wire). Suitable wires are available from Manhattan Wire Products, 68 Paulsboro Road, Woolwick Twp., N.J., 08085, USA.

The system is designed to operate at an ambient temperature of up to 100° F. (38° C.), with a normal operating temperature for the transfer pipe of 850° F. (450° C.), and a maximum operating temperature for the pipe of 932° F. (500° C.). The pipe 18 is intended to heat up from ambient (75° F.) to 350° C. in 17 minutes, and from ambient (75° F.) to 450° C. in 25 minutes. The pipe expansion at 450° C. is 0.4 inches. The input voltage to the power supply 50 is 208 volts, 3-phase, and the power delivery of the power supply ranges from 0 to 5 kilowatts.

It has been found that good power transfer (high inductive heating efficiency) is achieved when groups of coils are intermittently disposed along the length of the pipe, as opposed to having a constant coil pitch along the length of the pipe. These groups of coils act as individual inductors in series. Alternatively, multiple sets of coil groups may be used, the group(s) within each set being powered in series, but the separate sets being powered in parallel.

### 2. Alternative Coil Configurations

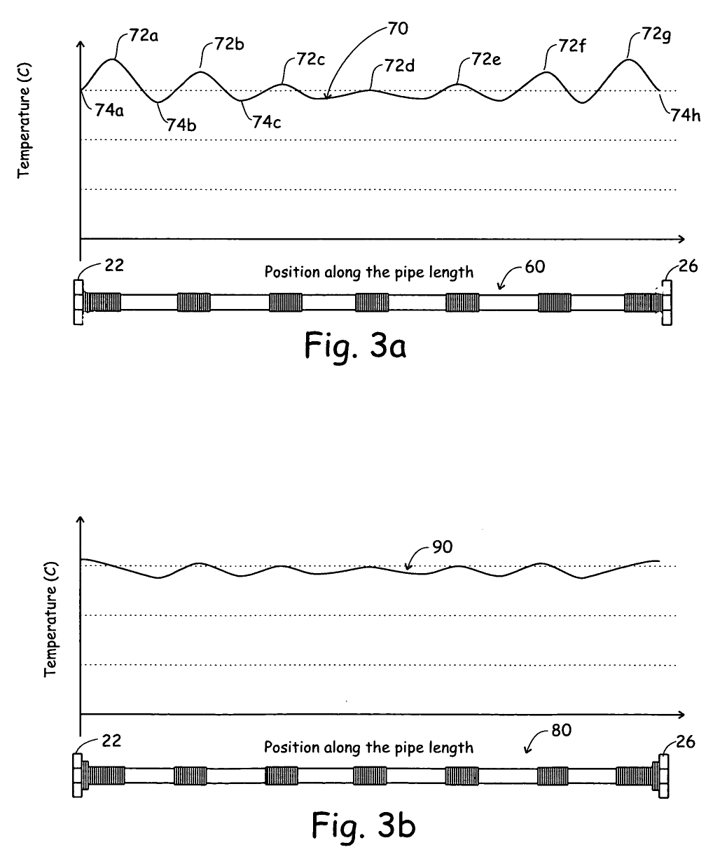

FIG. 2a illustrates schematically one embodiment of a heating coil configuration 60 on a transfer pipe. The number (N) of coil turns in each group, which may be the same or different, determines the equivalent eddy current resistance for the corresponding area of the pipe. For example, using (as shown in FIG. 2a) an evenly spaced coil group configuration of 7 groups (62a-62g) of 15 turns per group, a thermal profile 70 can be achieved, as shown in FIG. 3a, with temperature peaks (72a-72g) at the center of the coil groups. In this profile 70, there are cold spots (e.g., 74b, 74c) in between the coil groups and at the ends of the pipe (e.g., 74a, 74b).

Alternatively, as shown in FIG. 2b, providing a coil configuration 80, similar to coil configuration 60, but with multiple layers of coils (and thus more turns) in the groups (82a, 82e) near each end of the pipe allows the ends to heat up to a temperature closer to the range of the central portion of the pipe. Thus, as shown in FIG. 3b, the resulting temperature profile 90 is substantially more uniform along the length of the pipe, with much shallower peaks at the locations of the coil groups (82a-82e). Depending on the application, a suitable coil design (e.g., number of groups, coils per group, type of coil, allowable temperature variation along the pipe, etc.) can be determined.

Certain alternative coil configurations are illustrated in FIGS. 4-6. FIG. 4a illustrates how multiple layers can be provided at an end coil group located adjacent either the input or output end of a transfer pipe 18. In this embodiment, the coil configuration includes adjacent one end of the pipe a radially inner coil group 42a wound around the pipe 18, covered by a radially outer coil group 42b. The outer coil group 42b may cover some or all of the inner coil group 42a and is designed to increase the level of magnetic flux, and thus increase the inductive heating, at the end of the pipe 18. This is often required where the ends of the pipe 18 cool more quickly because they are in physical contact with an adjacent component at a lower temperature. The inner and outer coil groups 42a and 42b can be connected in series or in parallel, as long as the direction of flux is the same.

FIG. 4b shows another embodiment in which, instead of multiple overlapping coil groups at the end of pipe 18, an end coil group 42c includes, adjacent pipe flange 26, a radially outwardly extending spiral or pancake coil section 42d, extending transversely to the main coil section wound around the pipe 18. This spiral (pancake) design provides an increase in magnetic flux at the end of the pipe, for the same reasons as previously described with respect to FIG. 4a. A radial gap is provided between the outer thermal sheath 48 and the flange end 26, to accommodate the spiral coil configuration 42d.

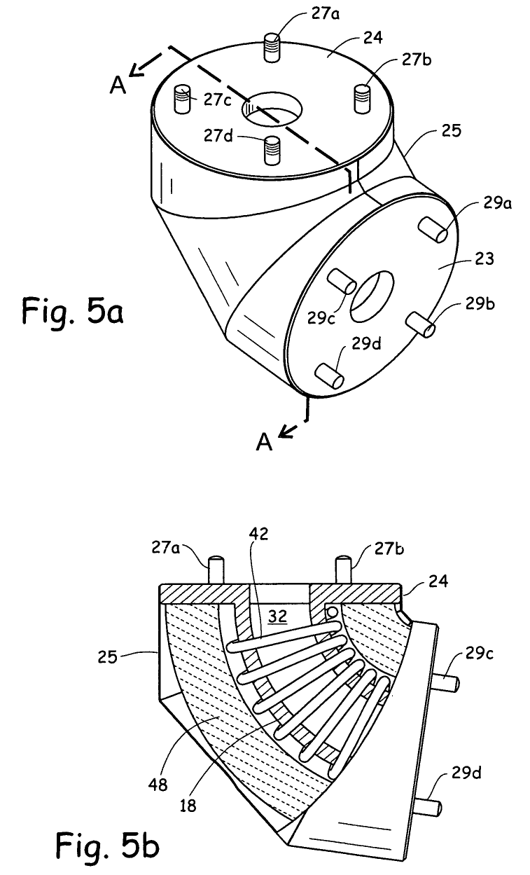

FIGS. 5a-5b illustrate exterior and interior views of a curved transfer pipe section of the type illustrated at output end 24 of the pipe assembly 10 in FIG. 1a. An outer housing 25 encloses the curved end of the thermal insulating sheath 48 and transfer pipe 18. The end flange 24 of pipe 18 has four symmetrically spaced connectors 27a-27d for joining the pipe to the tundish flange 26. At the opposite end of housing 25, there is another pipe flange 23 with four connectors 29a-29d for connection to the straight main portion of the transfer pipe assembly 10. As shown in FIG. 5b, within the housing 25 there is centrally disposed the curved transfer pipe 18, surrounded by coil 42, which in turn is surrounded by thermal sheath 48. The coil configuration includes more widely spaced turns, at least on the outer edge of the curve. The resulting heating profile in the pipe is relatively constant. It is possible to double-up the turns or add a spiral at the flanges to increase the flux density locally.

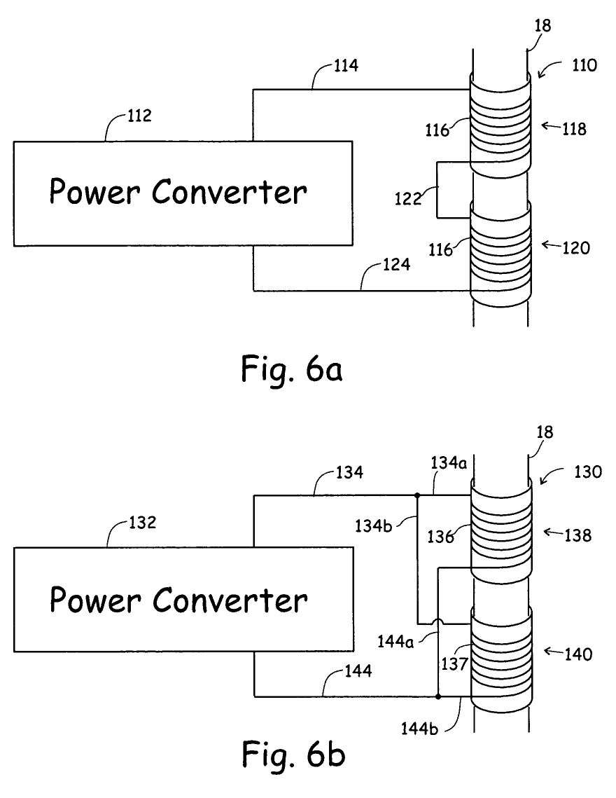

FIGS. 6a-6b show schematically two methods and apparatus for powering the coil groups along a pipe length either in series or in parallel. In FIG. 6a, a series coil configuration 110 is provided in which a power converter 112 has one input lead 114 attached to one end of coil 116 wound around a portion of pipe 18. The coil 116 is configured in two groups, first coil group 118 and second coil group 120, connected in series by a connecting lead 122. A return lead 124 connects the second coil group 120 to the power converter 112.

In an alternative coil configuration 130, shown in FIG. 6b, a power converter 132 has an input lead 134 which is split into two branches 134a and 134b to supply each of first and second coil groups 138 and 140 respectively. First input lead 134 connects to coil 135 wound around a first portion of pipe 18 forming the first coil group 138, and is connected by return lead portion 144a to power converter 132. Similarly, a second coil 137 is wound around second portion of pipe 18 forming the second coil group 140, and is connected by return lead 144b to the power converter 132.

### 3. Method of Determining a Coil Configuration

One example of a method for determining a coil configuration will now be described. This method is only one embodiment of the invention and is not meant to be limiting.

In this example, we calculate a coil configuration, namely the number of coil groups (n) and the number of turns in a coil group (N) for a straight section of pipe of length (L). This coil configuration is selected to provide a total coil resistance Rₜₒₜ within a range of from Rₘᵢₙ to Rₘₐₓ, for a required power input Pₜₒₜ to heat or maintain the temperature of the pipe (and/or a material in the pipe), given the thermal losses of the system. The lower and upper limits (Rₘᵢₙ and Rₘₐₓ) will generally depend on the current and voltage limits of the coil and power supply (as described below), and the selection of a particular value of Rₜₒₜ within the range will depend on the particular application. For example, the selection may involve a trade off between achieving a higher energy efficiency and a higher thermal uniformity along the length of the pipe.

The described heating method is particularly useful with a pipe having a high aspect ratio, where the aspect ratio is defined as the ratio of pipe length to pipe outer diameter. The aspect ratio is preferably at least 5:1, more preferably 10:1, and still more preferably at least 25:1 or greater.

In this example the variables at issue include:

### Electrical

Vₘₐₓ—Maximum tolerable voltage [V]

I—Current in coil, RMS [A]

R_{1,2,3}—Equivalent resistance of coil groups 1, 2, 3 etc . . . [Ω]

Rₜₒₜ—Total equivalent resistance of the heating system [Ω]

### Geometrical

L-Length of pipe [m]

rₘ—Inner radius of pipe [m]

rᵢ—Outer radius of pipe [m]

rₒ—Outer diameter of pipe insulation [m]

d—Diameter of coil wire [m]

A—Flow area of pipe [m²]

N_{1,2,3 . . .} —Number of turns in coil groups 1, 2, 3 etc . . .

n-Number of coil groups

### Thermal

m-Mass flow rate of material through pipe [kg/s]

Cₚ—Specific heat capacity of material in pipe [J/kg° C.]

P—Power input [W]

T_{∞}—Ambient temperature [° C.]

T₁—Input temperature [° C.]

T₂—Output temperature [° C.]

h_{θ}—Heat transfer coefficient from coil surface [W/m²° C.]

kᵢ—Thermal conductivity of pipe insulation material [W/m° C.]

For ease of understanding, the method is described below as involving seven (7) steps, although neither the ordering nor the differentiation between steps is meant to be limiting:

1) given a required total power (Pₜₒₜ) to heat or maintain the pipe (or the material in the pipe) at a desired temperature profile;

2) given a maximum coil temperature limit (Tₘₐₓ), calculate a current maximum Iₘₐₓ for the coil assembly;

3) utilizing Pₜₒₜ and Iₘₐₓ to calculate the minimum total resistance Rₘᵢₙ where Rₘᵢₙ equals Pₜₒₜ/I²ₘₐₓ;

4) given a maximum voltage limit Vₘₐₓ of the coil and power supply;

5) utilizing Vₘₐₓ and an anticipated shape of the current signal in the load (coil and pipe) to calculate the average voltage Vₐᵥₑ;

6) utilizing Vₐᵥₑ and Pₜₒₜ to calculate the maximum total resistance where Rₘₐₓ equals V²ₐᵥₑ/Pₜₒₜ;

7) design a coil configuration with (n) number of coil groups and (N) number of turns in coil groups where the coil configuration has a total resistance Rₜₒₜ in the range of Rₘᵢₙ≦Rₜₒₜ≦Rₘₐₓ.

The total power input of the pipe must account for both the thermal losses of the system and the energy to be added to the material in the pipe channel in order to heat or maintain the material at a desired temperature. The following equation may be used to calculate the total power input Pₜₒₜ where the first term represents the energy added to the material and the second term represents the thermal losses:

$${P}_{tot} = ( {T}_{2} - {T}_{1} ) {C}_{p} m + \frac{{T}_{i} - {T}_{∞}}{\frac{1}{h 2 π {r}_{0} L} + \frac{ln ( {r}_{o} / {r}_{i} )}{2 π {k}_{i} L}}$$

The material in the pipe channel has a heat capacity Cₚ and flows through the pipe at a rate m. The material comes in one end of the pipe at a temperature T₁ and exits at the other end of the pipe at a temperature T₂.

The thermal losses in the system can be modeled by a radial heat transfer equation. In this example the system includes, in serial order from the center, a pipe, a layer of electrical insulation, a coil wrapped around the electrical insulation, a layer of thermal insulation over the coil, and ambient atmosphere surrounding the thermal insulation. The radial heat transfer, as described in the second term of the above equation for Pₜₒₜ, comprises a temperature gradient from the pipe inner diameter Tᵢ to the pipe outer diameter Tₒ, divided by a summation of a thermal flux at the outer surface of the pipe and a flux through the thermal insulation (where the intermediate coil and electrical insulation are assumed to be at the same temperature as the outer surface of the pipe).

A coil configuration will be designed which allows delivery of the necessary amount of power Pₜₒₜ within the geometrical constraints of the system, and while operating within the temperature limit of the coil and the voltage limit of the power supply.

The coil assembly generally has a temperature limit Tₘₐₓ above which it may fail. In order to operate at or below this maximum temperature, a balance is required between the resistive losses in the coil (resistive heat generated in the coil) and the thermal losses of the coil. The following equation may be utilized to calculate a current maximum Iₘₐₓ for a coil assembly having temperature limit Tₘₐₓ:

$${I}_{max} = \sqrt{\frac{{h}_{θ} π {d}^{3} Δ {T}_{max}}{4 {ρ}_{c}}}$$

where:
h_{θ}=Heat transfer coefficient from coil surface to ambient
d=Diameter of coil
ΔTₘₐₓ=Maximum tolerable temperature of coil less ambient temperature at the coil surface
ρ_{c}=Resistivity of coil material

The above equation can be derived by setting the ohmic losses due to the current flowing through the coil, namely P=I²R, where R (the coil resistance per unit length) equals πd²/4ρ_{c}, equal to the thermal losses of the coil, namely P=h_{θ}SΔTₘₐₓ, where S (the surface area of the coil per unit length) equals π·D, and P is the overall heat transfer equation for the system.

Given the maximum current and necessary power, a minimum total resistance of the system Rₘᵢₙ can be calculated from:

$${R}_{min} = \frac{{P}_{tot}}{{I}_{max}^{2}}$$

Given a maximum voltage of the power supply, typically determined by the voltage limits of the power supply switching components and coil, and based on the shape of the anticipated current signal in the load (coil and pipe), a maximum total resistance of the system Rₘₐₓ can be calculated from the following equation:

$${R}_{max} = \frac{{V}_{ave}^{2}}{{P}_{tot}}$$

The shape of the current signal in the load (coil and pipe) determines how one calculates Vₐᵥₑ from Vₘₐₓ. For an AC signal Vₐᵥₑ is the root mean square voltage, and for a DC signal Vₐᵥₑ is the time average of the voltage signal, where in both cases the voltage peaks are at Vₘₐₓ. For a signal comprising high frequency harmonic current pulses as described in paragraph 109:

$${V}_{ave} = \frac{{\int }_{O}^{T} \vert V \vert d t}{T}$$

where T is the period of the fundamental (root) frequency.

The total resistance is then calculated for various coil configurations, based on the number of coil groups (n) and number of turns in each coil group (N), such that the total resistance Rₜₒₜ falls in the range from Rₘᵢₙ to Rₘₐₓ (including the limits of the range). As described below, and with reference to FIG. 6, the following equation can be used to determine Rₜₒₜ:

$${R}_{tot} = 4 {ρ}_{c} nN \frac{D}{{d}^{2}} + n \frac{{N}^{2} π D}{( 4 + N ) d} \sqrt{ω ρ μ} \qquad ( Eqn . X )$$

where:
D=Diameter of pipe
d=Diameter of coil
μ=permeability of pipe material
ρ=Resistivity of pipe material
ω=Effective system frequency
ρ_{c}=Resistivity of coil material
n=Number of coil groups
N=Number of turns in each coil group

The first term in the equation for Rₜₒₜ represents the ohmic resistance in the coil. The second term represents the eddy current resistance in the pipe. The second term was found experimentally for a coil configured in discrete (spaced apart) groups along a length of the pipe, and differs from a traditional non-grouped coil design as described below.

FIG. 7a shows a traditional coil configuration in which a continuous coil is wrapped around the outer diameter of a pipe as a continuous series of adjacent coils along the entire pipe length. For discussion purposes, a schematic illustration showing a cross section of six such coils 150 is provided adjacent a portion of the pipe outer diameter 152. Each coil has an outer diameter (d) and the combined set of coils generates a field within the pipe (in area A) having a field height equal to the depth of penetration a and a width of penetration equal to the product Ned. In a traditional inductive heating system, it is generally understood that the eddy current resistance in the pipe (Rₑ) is:

$${R}_{{e}_{trad}} = {N}^{2} \cdot \frac{π D}{Nd} \cdot \sqrt{ω ρ μ}$$

where the term:

N² is based on the transformer law (number of turns squared); and

N·d=the width of penetration.

In contrast, FIG. 7b is a schematic diagram of the new coil configuration showing one discrete group 160 of six coils, each of outer diameter d, adjacent a portion of the pipe outer diameter 162. In this case it has been experimentally determined that the field generated in the pipe (in area A) has a height equal to the depth of the penetration δ and a width of penetration equal to the sum of (4d+Nd). As a result, the eddy current resistance is:

$${R}_{{e}_{new}} = {N}^{2} \cdot \frac{π D}{( 4 d + Nd )} \cdot \sqrt{ω ρ μ}$$

In addition, where the coils are provided in discrete groups, the coil configuration must also satisfy the following equation:

L>nNd+3d(n−1) (Eqn. Y)

This equation is based on the physical limitations of the system, namely that one cannot fit more coil turns along the length (L) of a pipe than there is available geometry given a coil of outer diameter d, n number of coil groups, and N number of turns in each coil group.

The possible coil configuration(s) must satisfy both of the equations for Rₜₒₜ and L, set forth above (equations X and Y). Multiple coil configurations may be suitable in a particular application which satisfy both equations.

Generally, a value of Rₜₒₜ closer to the upper limit of the range (Rₘₐₓ) would be selected where the user desires a coil configuration providing greater power efficiency. At the upper end of the range, a maximum coil voltage is provided. For an inductive power supply system, a condition of maximum voltage and minimum current provides the highest efficiency, because it provides the lowest ohmic (resistive) current losses in the coil. Alternatively, if it is desirable to provide a high thermal uniformity along the pipe, a value of Rₜₒₜ is selected closer to the lower end of the range (Rₘᵢₙ), where maximum current is provided in the coil.

The following iterative method may be used, for example, if maximum efficiency is desired, i.e., a value of Rₜₒₜ in the upper end of the range. The number of turns per group N is first set to one (1) and the number of groups (n) is solved for using equation X. The number of groups (n) must be a positive integer. Because it is desired to operate at the maximum resistance, the next lesser positive integer should be selected from the result. These values for n and N are then compared in the inequality (equation Y). If the inequality yields a false result, N is then set to two (2) and the process is repeated. This process is repeated, incrementing N until a true result is obtained.

In the case where n is set to two (2), and a true result is not returned, it is necessary to compare the minimum resistance (Rₘᵢₙ) and repeat the process in reverse, starting with n equal to two (2).

The described method will yield a coil configuration which emphasizes efficiency over thermal uniformity, while providing the necessary power. In contrast, if it is desired to emphasize thermal uniformity over efficiency, then it is desirable to operate at a lower resistance with a greater number of coil groups (n).

The above example also assumes that it is desired to provide a substantially uniform power delivery along the length of the pipe. In other applications, where greater localized power is desired, coils may be moved from one group to another without changing the total number of turns to compensate for the higher or lower losses at certain points along the pipe.

In summary, and as illustrated in FIG. 7b, by providing discrete groups of coils there is an increased area in which the eddy current flows through the pipe. This increase in area represents an effective decrease in coupling, and will generate less heat per unit area in the pipe. To increase the amount of heat generated per unit area, the eddy current should flow through a smaller area. In traditional inductive heating, this is accomplished by increasing the frequency, which decreases the depth of penetration. In the present application with discrete groups of coils, it is desirable to provide adjacent coil turns within a group in order to reduce the leakage field (i.e., 2d on each side of each turn). Also, the effect of this leakage field will vary depending upon the number of turns in the group. For example, compare a coil configuration of 2 turns per group with another configuration having 10 turns per group, where the same current is provided to each group. The 2-turn configuration will generate 2 units of current in the pipe, and a width of penetration of 6d. The ratio of current units to penetration width is 2:6. In contrast, the 10-turn configuration will generate 10 units of current in the pipe, and a penetration width of 14d. The second configuration yields a ratio of 10:14, which may be preferred because the eddy current is flowing through a smaller area and therefore there is an increase in the eddy current resistance (and heat generated per unit area).

As a further point of comparison, if a coil group has 1,000 turns, then the width of penetration is 1,004d. This provides an effective leakage of the field of only 0.4%. In contrast, with 2 turns the effective leakage is 66% of the field. Thus, providing a relatively high number of turns in each group substantially reduces the leakage field.

As another example, assume an application in which one is limited to 10 turns on the pipe. If one provides 5 groups of 2 turns per group, then 10 units of current are provided through 20 units of coil diameter (width of penetration). In contrast, one group of 10 turns would provide 10 units of current through 14 units of diameter (width of penetration). The second configuration, one group of 10 turns, is clearly better in providing a higher eddy current resistance (greater heat generated in a smaller area).

In general, providing discrete groups of coils is most beneficial in applications with a high aspect ratio (long and skinny pipe). In accordance with prior known systems, providing a continuous series of turns along the entire pipe length would likely generate an eddy current resistance so high as to be greater than critically damped (generating little if any heat in the pipe with reasonable voltage levels). In contrast, in accordance with the present embodiments the coil designer can begin dividing the coils into groups, starting with two groups, and determining whether the eddy current resistance has been reduced to less than Rₘₐₓ. This process can be repeated to achieve a desired combination of efficiency and uniformity of thermal profile.

The previously described addition of “4d” to the penetration width for a coil configuration having discrete groups (4d+Nd), was determined from experiments conducted at effective frequencies in a range of 50-150 kHz. At lower frequencies, the effect would be larger, and at higher frequencies, smaller. Thus the particular effect on the width of penetration will vary with the frequency of the applied signal. Utilizing a signal of current pulses providing high frequency harmonics in the coil (as previously described) provides a higher Rₘₐₓ (and thus higher efficiency) than a resonant sinusoidal frequency signal at the same fundamental frequency.

Various embodiments of the present invention allow an increase in efficiency in the ratio of power delivered to the pipe to the total system power. Efficiency is thus defined in the traditional sense of a ratio of useful work obtained to energy being expended. The losses in the system would include losses in the power supply, losses in the leads from the power supply to the pipe, losses in the coil assembly, etc. Thus, in the described embodiment the heating efficiency would be the ratio of the power input to the power supply to the inductive heating power supplied to the pipe. Generally, where the signal and coil allow lower currents (higher resistance), the power losses will be lower.

In the present invention, the coil turns within a group are adjacent one another in order to reduce the leakage field. Preferably, the coil turns are as close together as possible, as allowed by the electrical insulation between the coils. The insulation must provide a dielectric strength equal to Vₘₐₓ/N·n (namely, the voltage between adjacent turns). Preferably, the insulated coil turns are in direct contact. Less preferably, the turns have a pitch of 1, 1.5, or at most 2 coil diameters apart.

### 4. Overall Heater Coil Assembly Design, Materials, Signal and Heating Profiles

In regard to the coil requirements in various applications, in the metal casting industry it is common to see molten metal temperatures ranging from 400-700° C. Depending upon the amount of thermal conduction occurring between the coil 42 and pipe 18, the coil generally must be able to withstand a fairly high temperature as determined by the pipe operating temperature. At the lower end of the 400-700° C. range, a suitable coil is a nickel plated copper type MGT wire, of the type previously described. This wire is generally insulated with mica tape and a glass braid. The wire can generally withstand up to 540° C. in continuous use. At higher temperature applications, a pure nickel wire can be used with magnesium oxide or ceramic insulation.

The cross section of the coil wire may be selected such that resistive losses within the wire are less than 5% of the energy losses within the system. This also reduces self-heating of the wire, which can lead to detrimental thermal stresses and potentially exceeding the temperature rating of the electrical insulation.

For safety reasons, the coil is preferably covered with a protective sheath 48. The sheath is preferably thermally insulated to prevent heat losses to the environment. If the outer sheath is electrically conductive, it preferably does not create a closed electrical circuit around the outside of any one group of coils (or is spaced far enough away so that coupling is diminished), so as to minimize eddy currents flowing in (inductive heating of) the sheath. A long narrow slot breaking an electrically conductive sheath can be used. The sheath may be designed to function as (or otherwise include) a flux concentrator for increasing the magnetic coupling between the coil 42 and pipe 18.

The heated transfer pipe according to the present invention is not limited to specific materials, shapes or configurations of the components thereof. A particular application or environment will determine which materials, shapes and configurations are suitable.

For example, the inductor coil may be one or more of nickel, silver, copper and nickel/copper alloys. A nickel (or high percentage nickel alloy) coil is suitable for higher temperature applications (e.g., 500 to 1,000° C.). A copper (or high percentage copper alloy) coil may be sufficient for lower temperature applications (e.g., <500° C.). The coil may be stainless steel or Inconnel (a nickel alloy). The power leads supplying the inductor coil may be copper, nickel, Litz wire or other suitable materials. In the various embodiments described herein, water cooling of the coil is not required nor desirable due to the complexity, expense and power losses inherent in a water cooled system.

A dielectric insulation provided between one or more of the inductor coil 42, pipe 18 and/or outer sheath 48 may be a ceramic, such as one or more of magnesium oxide, alumina, and mica. The dielectric may be provided as a powder, sheet or a cast body surrounding the coil 42.

The pipe 18 may be made from a ferromagnetic metal, such as a carbon steel, 400 series stainless or a tool steel.

A flux concentrator may be provided as a tubular element disposed radially outwardly around the coil. The flux concentrator may be a solid, laminated and/or slotted element. For low temperature applications, it may be made of a non-electrically conductive ferromagnetic material, such as ferrite. For higher temperature applications it may comprise a soft magnetic alloy (e.g., cobalt).

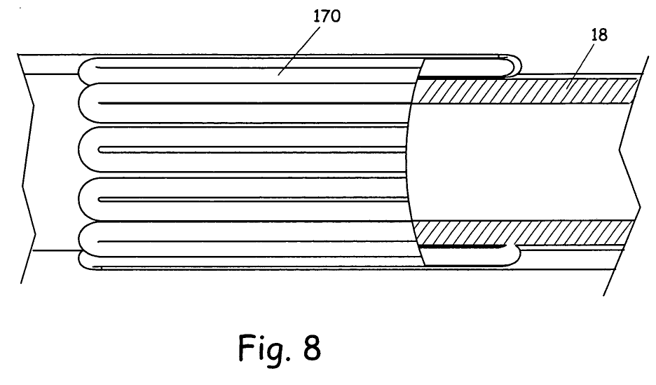

The coil geometry may take any of various configurations, such as helical (see coil 42 in FIG. 1b ) or serpentine (see coil 170 in FIG. 8). The coil cross-section may be circular, round, rectangular or half round. As used herein, coil is not limited to a particular geometry or configuration; a helical wound coil of circular cross section as shown is only one example.

In a more specific embodiment, given by way of example only and not meant to be limiting, the heater may comprise a pipe made of tool steel, a coil made of nickel, and electrical coil insulation made of alumina. The nickel coil and steel pipe can withstand the relatively high melt temperatures of metals such as magnesium. In this application a nickel coil will generally be operating above its Curie temperature, in order to be above the melt temperature of the magnesium; being above its Curie temperature will reduce the “skin-effect” resistive heating of the coil and thus reduce over-heating/burnout of the coil. The steel pipe will generally operate below its Curie temperature so as to be ferromagnetic (inductively heated); the pipe will transfer heat by conduction to raise the temperature of the magnesium in the bore of the pipe (during one or more of heat-up, normal flow, and/or transient operation). The steel pipe may be above its Curie temperature once the magnesium is flowing, e.g., while the magnesium is held in the melt state (e.g., for steady state operation or temperature control). The nickel coil will be cooled by conductive transmission to the sheath and/or ambient air.

Again, the specific materials, sizes, shapes and configurations of the various components will be selected depending upon the particular material to be heated, the cycle time, and other process parameters.

In various applications of the described inductive heating method and apparatus, it may generally be desirable that the various components have the following properties:
the coil is electrically conductive, can withstand a designated operating temperature, and is paramagnetic at the operating temperature;
the pipe is ferromagnetic at the desired operating temperature, is thermally conductive, is electrically conductive, and has a relatively uninterrupted path for the eddy current to flow;
the dielectric material is electrically insulative, thermally conductive, and substantially completely paramagnetic;
the flux concentrator does not exceed its Curie point during operation, has a high permeability, can withstand high operating temperatures, and has an interrupted (restricted) circumferential path for the eddy current to flow (thus reducing inductive heating of the flux concentrator relative to the pipe);
the coil and pipe (and optionally the coil and flux concentrator) are arranged to provide good inductive coupling.

In some applications, there may be direct coupling of the magnetic field to the material in the pipe bore and thus inductive heating of the material itself. In such applications, the desired parameters of the pipe are also desired parameters of the material.

The material in the pipe bore will also affect the parameters of the assembly components, the applied signal and the heating rates. In various embodiments, the material may include one or more of a molten metal and a polymer, e.g., a pure metal, a metal alloy, a metal/polymer mixture, etc. In other embodiments the assembly/process may be useful in food processing applications for transporting flowable materials, e.g., where grains and/or animal feed are extruded and cooled.

In various applications, it is desirable to supply a signal to the coil comprising current pulses having a desired amount of pulse energy in high frequency harmonics for inductive heating of the pipe, as described in Kagan U.S. Pat. Nos. 7,034,263 and 7,034,264, and in Kagan U.S. Patent Application Publication No. 2006/0076338 A1, published Apr. 13, 2006 (U.S. Ser. No. 11/264,780, entitled Method and Apparatus for Providing Harmonic Inductive Power). The current pulses are generally characterized as discrete narrow width pulses, separated by relatively long delays, wherein the pulses contain one or more steeply varying portions (large first derivatives) which provide harmonics of a fundamental (or root) frequency of the current in the coil. Preferably, each pulse comprises as least one steeply varying portion for delivering at least 50% of the pulse energy in the load circuit in high frequency harmonics. For example, the at least one steeply varying portion may have a maximum rate of change of at least five times greater than the maximum rate of change of a sinusoidal signal of the same fundamental frequency and RMS current amplitude. More preferably, each current pulse contains at least two complete oscillation cycles before damping to a level below 10% of an amplitude of a maximum peak in the current pulse. A power supply control apparatus is described in the referenced patents/application which includes a switching device that controls a charging circuit to deliver current pulses in the load circuit so that at least 50% (and more preferably at least 90%) of the energy stored in the charging circuit is delivered to the load circuit. Such current pulses can be used to enhance the rate, intensity and/or power of inductive heating delivered by a heating element and/or enhance the lifetime or reduce the cost and/or complexity of an inductive heating system. They are particularly useful in driving a relatively highly damped load, e.g., having a damping ratio in the range of 0.01 to 0.9, and more specifically in the range of 0.2 to 0.7, where the damping ratio, denoted by the Greek letter zeta, can be determined by measuring the amplitudes of two consecutive current peaks a₁, a₂ and using the following equation:

$$ζ = \frac{- ln ( \frac{{a}_{2}}{{a}_{1}} )}{2 π}$$

This damping ratio, which alternatively can be determined by measuring the amplitudes of two consecutive voltage peaks, can be used to select a desired current signal function for a particular load. The subject matter of the referenced Kagan patents/application are hereby incorporated by reference in their entirety.

The heating rates (temperature profiles) of the various heater assembly components are interdependent, as there is generally thermal communication between the coil and pipe, and also with the external sheath (if present) and/or the surrounding environment (e.g., ambient air). In the type of application previously described, initially the coil heats up most rapidly until it reaches its Curie temperature at which point the rate of heating of the coil is reduced and generally ultimately exceeded by the heating rate of the pipe. The flux concentrator (if present) remains ferromagnetic (below its Curie temperature) during both the dynamic and steady state periods. The flux concentrator may be heated both inductively, by the magnetic flux generated by the coil, but also by thermal conduction of heat generated in the coil. The pipe also is heated both inductively, due to the magnetic flux generated by the coil, and may also be heated by thermal conduction of resistive heat generated in the coil and transferred from the coil to the pipe. The pipe has a relatively steady (linearly increasing) rate of heating up until its Curie temperature is reached, at which point its rate of heating levels off (for steady state operation). Because the pipe is at the center of the assembly, and some of the resistive heat generated in the coil is transmitted inwardly to the pipe, the pipe temperature may ultimately exceed that of the coil. The molten material in the central pipe bore is heated substantially by thermal conduction from the pipe. Its heating rate generally follows that of the coil, with temperatures below that of the coil.

The “Curie point” or “Curie temperature” of a material is the temperature at which its relative permeability changes from a high value, e.g., greater than about 400, down to 1. The Curie point of some commonly used materials and their alloys (suitable in various applications) are set forth below:

manganese 50° C.

chromium 100° C.

ferrite 200 to 400° C.

nickel 300 to 400° C.

steel 700 to 800° C.

cobalt 800 to 1000° C.

The “skin effect” is another parameter affecting the heating rates of the various components. The skin effect increases the resistance of an electrical conductor by reducing the cross sectional area through which current can flow. Generally, the resistance of a conductor R is given by:

$$R = \frac{l}{σ A}$$

where σ is the conductivity of the conductor material, l is the conductor length and A is a cross sectional area of the current path in the conductor. The depth of penetration δ is:

$$δ \approx \frac{1}{\sqrt{π f μ {μ}_{0} σ}}$$

where μ is the relative permeability of the conductor material, μ₀ is the permeability of a vacuum, f is the frequency in Hz and σ is the material conductivity. The depth of penetration of current flow decreases as the frequency increases and/or permeability increases. The majority of the current (approximately 63%) flows within the depth of penetration and almost all current (approximately 95%) flows within 3δ.

The skin effect occurs in both the coil, as well as the flux concentrator and pipe (where eddy currents are inductively generated). In applications where the molten material (the material in the pipe) itself is inductively heated, the skin effect may also affect the inductive heating rate of the molten material. Thus, both the Curie temperature and skin effect will affect the relative rates of heating of the assembly components and the molten material.

In the described embodiment, the heating process is initiated by applying a source voltage potential across the coil causing increasing current to flow through the coil. The flow of current in the coil generates a magnetic field around the coil, proportional to the current through the coil. As the magnetic field grows it intersects the surrounding materials, namely the dielectric, the pipe, the material in the pipe bore, the outer sheath, and the flux concentrator (if present).

Because the pipe and flux concentrator are ferromagnetic, the magnetic field flows freely through these materials, causing eddy currents to flow therein. The eddy currents flow in a circumferential direction, opposing the direction of the current in an adjacent coil turn. Preferably, because the flux concentrator has an open current loop, the net current through any path is relatively low. However, the current path in the pipe is closed circumferentially and eddy currents flow freely therein, inductively heating the pipe. The eddy currents in the pipe encounter resistance to flow depending on the cross sectional area of the flow path and the material properties as previously described.

The current in the coil also encounters resistance and creates heat. When the temperature of the coil is below its Curie point, the effective cross section is very small and constrained (due to the skin effect) to an outer circumferential area of the coil. However, when the coil reaches its Curie point the skin effect is greatly reduced and the cross sectional area in which current flows is correspondingly increased, thus reducing the resistance and the rate of heat generated in the coil. Thus, prior to reaching its Curie point, the coil heats at a faster rate.

In applications where the molten material (in the pipe bore) is not itself inductively heated, the temperature of the molten material is completely dependent upon thermal conduction of heat from the pipe. Therefore, the temperature of the material always lags the pipe during heat up and is slightly cooler in steady state.

As used herein, heating includes adjusting, controlling and/or maintaining the temperature of the pipe and/or a material in the bore of the pipe.

These and other modifications will be readily apparent to the skilled person as included in the scope of the following claims.

1. A method of inductively heating a transfer pipe comprising:
providing a thermally-conductive pipe having a bore for transporting a material;
providing a continuous coil along an exterior length of the pipe, the coil being inductively coupled to the pipe and having spaced-apart coil groups along the pipe length, with adjacent coil turns in each group;
supplying a signal to the coil to generate a magnetic flux for inductively heating the pipe length, the signal comprising current pulses providing high frequency harmonics in the coil.

2. The method of claim 1, wherein the heating step includes maintaining a temperature of the pipe length and/or a material in the bore along the pipe length within a defined temperature range.

3. The method of claim 2, wherein the temperature is maintained with a flow of the material in the bore.

4. The method of claim 2, wherein the temperature is maintained with no flow of the material in the bore.

5. The method of claim 1, wherein the heating step includes increasing a temperature of a material in the bore along the pipe length to within a defined temperature range.

6. The method of claim 1, wherein the heating step includes preheating the pipe length prior to transporting a material in the bore.

7. The method of claim 1, wherein the heating step includes maintaining a temperature of a material in the bore at at least one end of the pipe length within a defined temperature range.

8. The method of claim 1, wherein the coil and pipe length form a load having a damping coefficient in a range of 0.1 to 0.9.

9. The method of claim 1, wherein the heating step includes maintaining a flow of a material in the bore along the pipe length, wherein the material is in a temperature range of 400-700° C.

10. The method of claim 1, wherein the pipe transports a molten material to a metal casting apparatus.

11. The method of claim 1, wherein the heating step includes resistive heating of the coil and in which at least a portion of the generated resistive heat is thermally conducted to the pipe length.

12. The method of claim 1, wherein the coil turns are wound in substantially cylindrical form around the pipe.

13. The method of claim 1, wherein the coil is maintained at a lower temperature than the pipe length.

14. The method of claim 1, wherein the pipe is of a material having a Curie temperature and the heating step includes maintaining the temperature of the pipe length below the Curie temperature.

15. An inductively heated transfer pipe assembly comprising:
a thermally-conductive pipe having a bore for transporting a material;
a continuous coil provided along an exterior length of the pipe, the coil being inductively coupled to the pipe, and the coil having spaced-apart coil groups along the pipe length, with adjacent coil turns in each group;
a source for supplying a signal to the coil for generating a magnetic flux for inductive heating of the pipe length, the signal comprising current pulses providing high frequency harmonics in the coil.

16. The assembly of claim 15, wherein the coil groups are substantially evenly spaced along the pipe length.

17. The assembly of claim 16, wherein the coil groups each have a same number of turns per group.

18. The assembly of claim 15, wherein at least some of the coil groups have a different number of turns.

19. The assembly of claim 15, wherein the coil groups are unevenly spaced along the pipe length.

20. The assembly of claim 15, wherein multiple layers of one or more coils are provided along at least a portion of the pipe length for intensifying the magnetic flux.

21. The assembly of claim 20, wherein the multiple layers are provided adjacent at least one end of the pipe length.

22. The assembly of claim 15, wherein the coil has a relatively greater number of turns adjacent at least one end of the pipe length.

23. The assembly of claim 15, wherein the pipe is provided between one or more of a furnace, pump, mold and rollers.

24. The assembly of claim 15, wherein the pipe is disposed between a source of molten metal material and a casting assembly.

25. The assembly of claim 15, wherein the coil and pipe length form a load having a damping coefficient in the range of 0.1 to 0.9.

26. The assembly of claim 15, wherein an aspect ratio of the pipe length to the pipe outer diameter along the pipe length is at least 5:1.

27. The assembly of claim 26, wherein the aspect ratio is at least 10:1.

28. The assembly of claim 26, wherein the aspect ratio is at least 25:1.

29. The assembly of claim 15, wherein the coil turns are wound in substantially cylindrical form around the pipe.

30. The assembly of claim 15, wherein multiple coils are provided along the same or different pipe lengths.

31. The assembly of claim 15, including an outer sheath, and wherein the coil is provided between the outer sheath and the pipe.

32. The assembly of claim 31, wherein the outer sheath provides thermal insulation.

33. The assembly of claim 31, wherein thermal insulation is provided between the outer sheath and the coil.

34. The assembly of claim 31, wherein the outer sheath is a flux concentrator.

35. The assembly of claim 15, wherein the coil and pipe are disposed such that:
the coil is wrapped around an exterior surface of the pipe;
the coil is disposed in a dielectric body which surrounds an exterior surface of the pipe; and/or
there is a gap between the coil and an exterior surface of the pipe in a range of 0.02 to 0.25 inches.

36. A method comprising:
providing a thermally-conductive pipe having a bore for transporting a material;
providing a continuous coil along an exterior length of the pipe, the coil being inductively coupled to the pipe and having spaced-apart coil groups along the pipe length, with adjacent coil turns in each group;
supplying a signal to the coil to generate a magnetic flux for inductive heating of the pipe length, the signal comprising current pulses providing high frequency harmonics in the coil; and
selecting a coil configuration having at least a number (n) of coil groups and at least a number (N) of turns per coil group to provide a desired heating efficiency for heating or maintaining the pipe length and/or a material in the bore of the pipe length at a desired temperature profile.

37. The method of claim 36, wherein an aspect ratio of the pipe length to the pipe outer diameter along the pipe length is at least 5:1.

38. The method of claim 37, wherein the aspect ratio is at least 10:1.

39. The method of claim 38, wherein the aspect ratio is at least 25:1.

40. The method of claim 36, wherein the coil configuration is selected to provide a total coil resistance Rₜₒₜ within a range of from Rₘᵢₙ to Rₘₐₓ, for a required power input Pₜₒₜ to heat or maintain a temperature profile of the pipe length and/or a material in the bore along the pipe length.

41. The method of claim 40, wherein the lower and upper limits Rₘᵢₙ and Rₘₐₓ are determined based on current and voltage limits of the coil and/or a source of the signal.

42. A method comprising:
providing a thermally-conductive pipe having a bore for transporting a material;
providing a continuous coil along an exterior length of the pipe, the coil being inductively coupled to the pipe and having spaced-apart coil groups along the pipe length, with adjacent coils in each group;
supplying a signal to the coil to generate a magnetic flux for inductive heating of the pipe length, and
providing a coil configuration having at least a number (n) of coil groups and at least a number (N) of turns in each coil group, wherein the coil configuration is determined by:
determining a required total power Pₜₒₜ to heat or maintain the pipe length or a material in the bore of the pipe length at a desired temperature profile;
determining, for a maximum voltage limit of the coil and a source of the signal, an average voltage Vₐᵥₑ;
determining a maximum total resistance where Rₘₐₓ equals V²_{ave/P}ₜₒₜ; and
determining the number (n) of coil groups and the number (N) of turns in each coil group such that the coil configuration provides a total resistance Rₜₒₜ less than Rₘₐₓ.

43. The method of claim 42, wherein the coil configuration is selected to provide a desired combination of heating efficiency and uniformity of thermal profile in one or more of the pipe length and a material in the bore along the pipe length.

44. The method of claim 42, wherein the coil configuration is determined to provide a total resistance Rₜₒₜ greater than a minimum resistance Rₘᵢₙ, where Rₘᵢₙ is determined based on a maximum current limit of the coil.

45. The method of claim 42, wherein multiple coils are provided and supplied the signal in parallel.
